(19) United States
(12) Patent Application Publication
(10) Pub. No.: US 2009/0216576 A1
(43) Pub. Date: Aug. 27, 2009

(54) METHOD FOR CONSTRAINED BUSINESS PLAN OPTIMIZATION BASED ON ATTRIBUTES

(75) Inventors: Baruch Ismail SAEED, Berkeley, CA (US); Geoffrey Alexander Boushey, San Francisco, CA (US)

Correspondence Address: SUGHRUE MION, PLLC, 2100 Pennsylvania Avenue, N.W., Washington, DC, 20037, US

(73) Assignee: Maxager Technology, Inc., San Rafael, CA (US)

(21) Appl. No.: 12/035,207

(22) Filed: Feb. 21, 2008

(51) Int. Cl. G06Q 10/00

(52) U.S. Cl. 705/7

(57) ABSTRACT

A method for constrained business plan optimization based on attributes. The method, according to one embodiment, uses business data of a manufacturer to generate constrained business plans using one or more attribute-based constraints. The method is highly efficient in organizations having a complex organizational structure, multiple interactive production flows, many products, many customers and the need to rapidly add attribute-based constraints. It allows managers to make better strategic and tactical decisions regarding their business, thereby maximizing profit while satisfying constraints.

### FIELD OF THE INVENTION

The present invention generally relates to enterprise information systems, and more particularly, to a method for creating an optimized constrained business plan.

### BACKGROUND OF THE INVENTION

Increasingly, in the current competitive business climate, there is a profit driven motive to maximize the profitability of products and services (collectively referred to as “products”) that are provided or marketed to customers. Enterprises typically use business planning to make decisions in order to maximize profits.

Generally, business planning is the process of acquiring operational information from business units in the organization in order to create, integrate, and execute the next series of operational plans and financial budgets. The process normally entails that each logical organization of the business gathers information from logical sub-organizations, which in turn, themselves gather information from their sub-organizations, to a desired level of abstraction, usually at product, process and customer levels.

The business information is often collected from multiple data sources, such as individual spreadsheets, online transaction processing (OLTP) applications, and specialized databases, called operational data stores (ODS). The OLTP applications are enterprise systems that manage a company's basic transactions, such as supply chain management (SCM), customer relationship management (CRM), and enterprise resource planning (ERP). Using the business planning tools, managers can make decisions that allocate resources in an attempt to maximize profits. For example, key decisions include, but are not limited to, determining which new products to introduce, which suppliers to use, which capital investments to make, and what prices to charge.

Due to increasing environmental awareness, regulation and social pressure, manufacturers such as those with chemical processes and fossil fuel-burning plants must take into consideration environmental constraints when implementing their business plans. An example of such a constraint is for minimum fuel efficiency for United States auto manufacturers (also known as the CAFE standard). Typically, this standard defines the minimum average fuel efficiency (expressed in miles per gallon (MPG)) by vehicle category. Another example of an environmental constraint is a maximum amount of mercury that a chemical plant may emit.

Manufacturers may also consider other constraints, such as market-based, asset-based, resource-based, and economic constraints when developing business plans. For example, market-based constraints may define a minimum guaranteed quantity to sell of all products combined within a certain product category to a specific customer. The manufacturer may have a maximum capacity for each manufacturing machine. Resource-based constraints include the minimum amount of material that a manufacturer purchases from a supplier company. Economic constraints include a target of a certain amount of revenue growth in a new market that the manufacturer is committed to.

In the related art, there are many tools for facilitating a business planning process. Some of the conventional tools are based on linear programming models and are often inefficient and time consuming. This is due to the fact that the business planning process must be orchestrated between and across multiple organizations, each of which may have its own information tracking and planning model. To simplify their analyses, organizations typically aggregate detailed information prior to making resource allocation decisions, thereby introducing inaccuracies into the planning process and, potentially, infeasibility into the plans. Furthermore, constraints assigned to such models, such as resource availability, asset (e.g., machine) capacity availability, and maximum potential demand levels by product and by customer, may be incompatible, therefore the overall planning results are not efficiently, or otherwise globally, optimized.

Sophisticated tools for business planning are piecemeal and fail to capture the myriad of interconnections, constraints and tradeoffs that significantly impact the underlying economics of the business. Furthermore, such tools are not feasible for complex organizations that may have multiple business units and multiple interactive, constrained production flows. These tools may include spreadsheets, activity-based costing systems, simulation and optimization packages, and the like. Another disadvantage of conventional tools is that they cannot optimize business planning according to specific attributes (such as product and customer attributes) or combinations of attributes, thereby hindering managers' abilities to make decisions with regard to their business. For example, these decisions include decisions like which product lines to offer, which products within product lines to offer, which customers should be emphasized, which markets should be served, and so on.

In addition, conventional business planning tools do not provide the ability to rapidly create externality, resource, asset, market and financial constraints based on attributes. Attributes may include a plant, a region, a customer, an asset (e.g., a machine), and so on. This is a major drawback as manufacturers cannot determine how these constraints would affect their profitability. For example, a government agency may be interested in setting a limit on the amount of an emission in a certain region. A rapid ability to capture this constraint and test its effects on the business plan would help the company in responding to the proposed limit. As another example, a manufacturer may be interested in restricting its carbon dioxide emissions in the United States, and, in a similar fashion, the manufacturer could test the economic impact of the proposed emissions limit. As yet another example, a manufacturer may be negotiating with a customer, and the customer may desire a guaranteed minimum quantity commitment for its delivery destinations in China. The manufacturer can determine the overall economic impact on the business plan and use this information in negotiating prices with the customer.

Therefore, it would be highly desirable to provide a solution that rapidly creates and assesses the effects of constraints by attributes on business plans.

### BRIEF DESCRIPTION OF THE DRAWINGS

FIG. 1 is a flowchart describing the method of generating an optimized business plan in accordance with an embodiment of the present invention.

FIG. 2 is a flowchart describing the process of optimizing according to attributes in accordance with an embodiment of the present invention.

FIG. 3 is an output generated by an embodiment of the present invention.

### DETAILED DESCRIPTION OF THE PREFERRED EMBODIMENTS

The method, according to one embodiment, uses business data of a manufacturer to optimize business plans constrained by one or more attribute-based constraints. The method is highly efficient in organizations having a complex organizational structure, multiple interactive production flows, many products, many customers and the need to rapidly add, modify and assess attribute-based constraints. It allows managers to make better strategic and tactical decisions regarding their business, thereby maximizing profit while satisfying constraints.

Examples for the constraints above may include, but are not limited to: environmental constraints (e.g., emissions caps, minimum fuel efficiency, etc.), resource constraints (e.g., minimum material commitments, maximum material allocations), asset constraints (e.g., assets' capacities), market constraints such as those set by customers (e.g., minimum quantity for a set of products, maximum price for a set products, etc.), and economic constraints (e.g., revenue targets). These constraints can be grouped according to one or more attributes. For example, a limit on mercury emissions is typically summed across all production activities at a plant. A minimum fuel efficiency standard may be for passenger vehicles produced in the United Sates, with a weighted average of fuel efficiency by model, weighted by production volume by car model. A minimum guaranteed quantity to sell to a customer is summed across all delivery destinations (e.g., stores or warehouses) for a customer. A revenue target may be grouped by product and/or region where sales orders' product quantities that were sold are summed. In these examples, a plant, a country (e.g., United States), a customer, a product, and a region are attributes and their values are used for grouping.

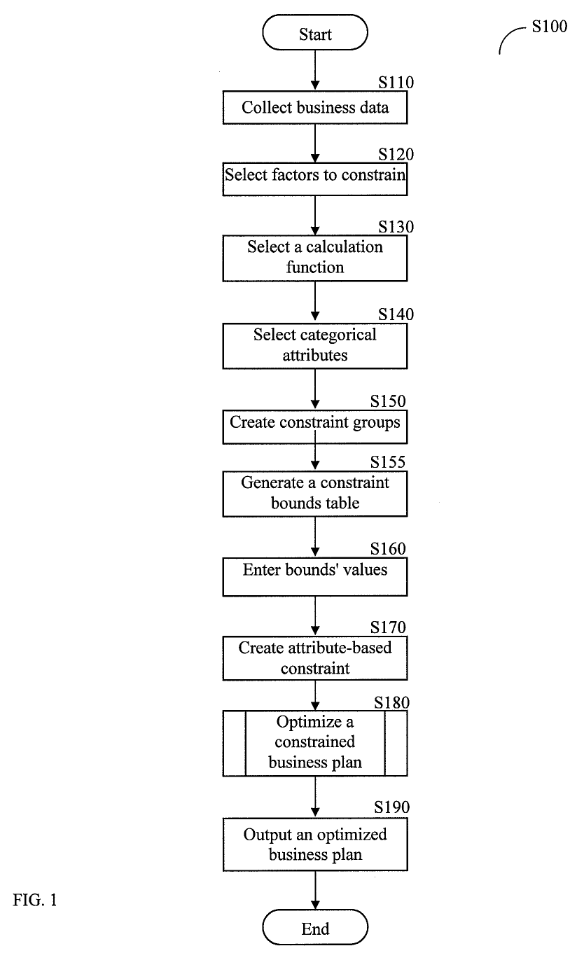

FIG. 1 shows an exemplary and non-limiting flowchart 100 describing the process of optimizing a constrained business plan implemented in accordance with an embodiment of the present invention. At S110, business data of the organization is collected from multiple data sources, such as those described above, including but not limited to, individual spreadsheets, online transaction processing (OLTP) applications, and specialized databases, called operational data stores (ODS). Specifically, the data includes financial data (e.g., production costs, shipping costs, labor costs, etc.), marketing data (e.g., product lists, new product lists, product attributes, etc.), sales data (e.g., customer lists, new customer lists, customer attributes, sales orders, sales order attributes, etc.), and production data (e.g., asset capabilities, asset rates, routings, etc.). In an exemplary embodiment, the term “asset” refers to a machine, the term “asset capability” refers to the product types that each machine can produce, and the term “routing” refers to the sequence of assets used in production. A sales order includes price and demand quantity information for a unique combination of product and customer attributes. The business data may be based on historical or projected details.

At S120, one or more numerical factors to constrain are selected. These factors include, but are not limited to, a customer quantity, a specific amount of emissions, an economic value, fuel efficiency for a vehicle category, an amount of a resource (water, electricity, coal, etc.), an amount of a form of waste (scrap, rework, etc.) and so on. It should be noted that other types of factors may be constrained and that different factors may be defined depending on the industry or business.

At S130, a constraint calculation function is selected. This function may include, but is not limited to, a sum, a weighted sum, a weighted average, and so on. Optionally, if a weighted calculation function has been selected, a user needs to define a weighting factor or equation for that function.

At S140, the user selects one or more categorical attributes. The categorical attributes define the level of granularity of decision making in the decision system. These attributes are predefined based on the numerical factor being constrained and may be, but are not limited to, a combination of customer region, a customer industry, a customer market, a sales order, a deliver-to destination, a product market segment, a product group, a product width, a product gauge, a sales person region, an asset, a plant, a production region, and so on. It should be noted that other types of categorical attributes may be defined by the user, the same attributes may be used in other attribute combinations (e.g., to cap global carbon dioxide emissions in additional to regional carbon dioxide emissions), different attributes may apply to different factors, and the attributes may be different depending on the industry or business.

At S150, based on the selected categorical attributes, constraints by groups of attributes values (hereinafter “constraint groups”) are created. A constraint group is a combination of different categorical attributes' values of different attributes. In each constraint group, the factor's quantities with identical attribute values across a selected group of attributes are summed or averaged according to the selected calculation function and, optionally, a weighting factor. At S155 a table including lower and upper bounds for each constraint group is generated and displayed to the user. At S160, the user specifies the values of the lower and upper bounds. The values may be set to null. At S170, based on the user's inputs, an attribute-based constraint for each bound with a value different from null is generated.

The following is a non-limiting example that describes the process for creating constraint groups and an attribute-based constraint. A company decides to restrict its carbon dioxide (CO₂) emissions at its factories in the United States (US). The company already trades CO₂ emissions credits in the European Union (EU) and it does not consider CO₂ emissions in the Asia Pacific (AP) or South America (SA). In this case, a user (e.g., a business manager) selects “CO₂ emissions” as the numerical factor to constrain, “SUM” as the constraint calculation function, and “Region” as the categorical attribute. Then, a table of lower and upper bounds are generated as illustrated in Table 1.

TABLE 1

| Region | Lower Bound | Upper Bound |
|---|---|---|
| US | Null | 10,000 |
| EU | Null | null |
| AP | Null | null |
| SA | Null | null |

In this case, the user specifies only an upper bound for CO₂ emissions in the US and sets the lower bound to a null (or ‘don't care’) value. Thereafter, the method automatically creates a constraint according to the values entered by the user. The constraint ensures that the sum of CO₂ emissions for the production of all products on all machines in all plants in the US is less than or equal to the upper bound specified by the user.

The following is another example describing the process for a user to determine the attribute-based constraints of the business plan. A car manufacturer manufactures three different categories of vehicles: passenger cars, light trucks and heavy trucks for the USA and UK markets. For each of these markets, the car manufacturer must produce a mix of cars that meet certain minimum average fuel efficiency by vehicle category. The car manufacturer optimizes its business plans by taking into account the efficiency standards in these countries for those vehicle categories. Each car has two categorical attributes, “Product” and “Vehicle Category” and a numerical attribute, “Miles per Gallon”. The “Product” attribute is the specific vehicle model; the “Vehicle Category” attribute can be either “Passenger Cars”, “Light Trucks”, or “Heavy Trucks”. The numerical attribute “Miles per Gallon” gives the fuel efficiency of a specific vehicle. Vehicles are produced on production lines with the following categorical attributes: “Production Line,” “Plant,” and “Country.” “Production Line” has attribute values such as “Line 1” , “Line 2” , and so on. “Plant” has attribute values such as “Chicago”, “Atlanta”, “Warren A”, and so on. “Country” has attribute values of “USA” and “UK.”

The user selects “Miles per Gallon” as the factor to constrain, “Weighted Average” as the constraint calculation function, and “Production Quantity,” which is the optimal amount of the Product produced by Production Line, as the weighting factor. The user also selects the categorical attributes of “Country” and “Vehicle Category” as the constraining attributes. In this example, six constraints groups of the categorical attribute combinations are created: a) a group including “USA” and “Passenger Cars”; b) a group for “UK” and “Passenger Cars”; c) a group for “USA” and “Light Trucks”; d) a group for “UK” and “Light Trucks”; e) a group for “USA” and “Heavy Trucks”; and f) a group for “UK” and “Heavy Trucks”.

Then, a table (e.g., Table 2) is generated for the user to enter constraint lower and upper bounds for each of these groups.

TABLE 2

| Country | Vehicle Category | Lower Bound | Upper Bound |
|---|---|---|---|
| USA | Passenger Cars | 25 | null |
| USA | Light Trucks | 20 | null |
| USA | Heavy Trucks | 10 | null |
| UK | Passenger Cars | 30 | null |
| UK | Light Trucks | 25 | null |
| UK | Heavy Trucks | 15 | null |

Since the company is only interested in exceeding minimum fuel efficiency standards, the user specifies the standards as the lower bounds and sets the upper bounds to a null value. The method automatically generates constraints of the following form:

$$\frac{\sum ( MilesPerGallon * ProductionQuantity )}{\sum ProductionQuantity} \geq MinimumFuelEfficiency$$

where the Minimum Fuel Efficiency is measured in MPG and appears in the table as the Lower Bound, and the sums are over the remaining categorical attributes of “Production Line” and “Plant.”

The following are two non-limiting examples for rudimentary forms of attribute-based constraints. A first typically-mandatory attribute-based constraint is the demand constraint. The demand constraints ensure that the quantities stay within the specified minimum and maximum boundaries for each sales order. An exemplary set of demand constraints for a particular sales order may be in following form:

minimum commitment≦sales order quantity≦maximum demand

The creation of demand constraints includes selection of a “Demand” as the factor to constrain, the “SUM” as the constraint calculation function and the categorical attributes “Customer” and “Deliver-to Location”, “Gauge”, “Grade”, and “Width”.

The attribute values are always specified for each attribute value combination. A “Lower Bound” represents the minimum commitment of the product to the customer at the deliver-to location. An “Upper Bound” represents the maximum demand of the product by the customer at the deliver-to location and is typically mandatory. An example for the attributes' values is shown in Table 3.

TABLE 3

| | Deliver-to | | | | Lower | Upper |
|---|---|---|---|---|---|---|
| Customer | Location | Gauge | Grade | Width | Bound | Bound |
| C1 | 94705 | 0.001 | A1 | 14.00 | 5,000 | 10,000 |
| C1 | 94331 | 0.001 | A2 | 14.00 | null | 8,500 |
| C2 | 48335 | 0.003 | A1 | 12.00 | null | 14,000 |
| C2 | 48123 | 0.003 | A1 | 12.00 | 6,300 | 6,300 |

In this example, the company must provide at least 5,000 and at most 10,000 units to customer C1 at deliver-to location 94705 of a product with Gauge 0.001, Grade A1, and Width 14.00. The items with Lower Bounds of null values have only upper bound limits, and thus the lower bounds are ignored.

Another typically-mandatory form of attribute-based constraints is a capacity constraint. The capacity constraints ensure the assets' utilized times does not exceed their available times, and, optionally, the asset must be used a minimum amount of time. An exemplary capacity constraint might take the following form:

$$\begin{matrix}Minimum Asset \\ Minutes Used\end{matrix} \leq \sum ( \begin{matrix}Quantity \\ in Units\end{matrix} \times \begin{matrix}Asset Minutes \\ Utilized per Unit\end{matrix} ) \leq \begin{matrix}Asset Minutes \\ Available\end{matrix}$$

where the sum is over all products processed on the asset, the Quantity in Units is the quantity of a specific product, the Asset Minutes Utilized per Unit is the average amount of time required to produce one unit on the asset, and the Asset Minutes Available is the capacity of the asset over the planning period. This is also a rudimentary form of attribute-based constraints, where the factor is Quantity in Units, the constraint calculation function is Weighted Sum, the weighting factor is Asset Minutes Utilized per Unit, and the attribute is “Asset”. In this case, the Minimum Asset Minutes Used is the “Lower Bound”. It is typically left blank but may be set if, for example, a machine must run a certain amount of time for it to function properly. The Asset Minutes Available is the “Upper Bound” and is typically mandatory. The Asset Minutes Utilized per Unit and the Asset Minutes Available are usually pre-specified, but they could be modified by the user. An example is shown in Table 4.

TABLE 4

| Asset | Lower Bound | Upper Bound |
|---|---|---|
| Base 1 | 7,884 | 8,322 |
| Base 2 | 7,884 | 7,884 |
| Finish A | null | 8,322 |
| Finish B | null | 8,322 |

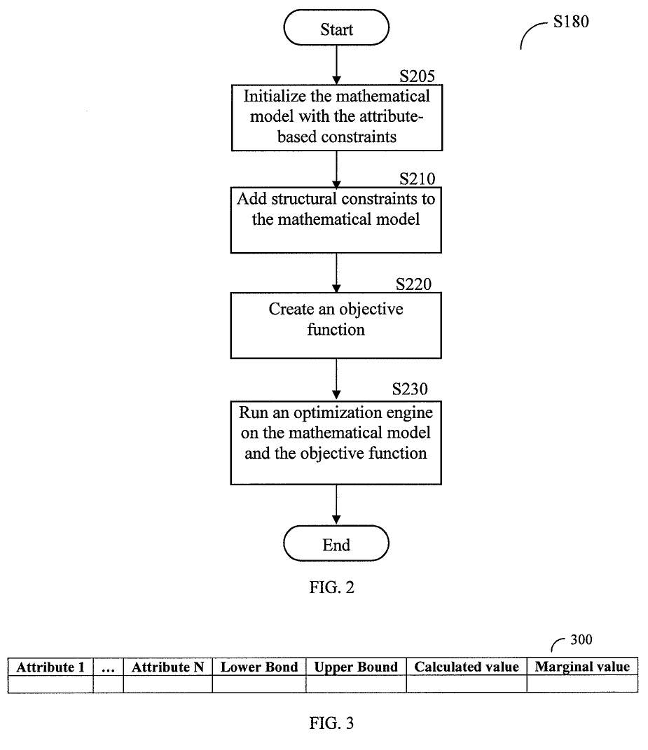

At S180, once the attribute-based constraints are generated, an optimization process is carried out. Referring now to FIG. 2, step S180 is described in greater detail. At S205, a mathematical model is initialized with the constructed constraint groups. The attribute-based constraints already include the demand and capacity constraints which are part of any mathematical model of a typical business plan.

At S210, a set of constraints representing structural business factors, such as production flows and shipping is added to the mathematical model. It would be apparent to a person skilled in the art that other types of constraints are possible. The production flow constraint(s) ensure that the products are manufactured according to pre-specified steps. For example, in a paper company, products are created through a sequence of steps including fiber supply, digester, bleach plant, paper machine, finishing machine, and, finally, shipping of the products. These relationships describe the structure of the production system and are not characterized by attribute-based constraints. The production flow may be modeled as described in U.S. application Ser. No. 11/860,473 (hereinafter the '473 application) assigned to common assignee and which is hereby incorporated herein in its entirety by this reference thereto. The shipping constraints ensure that the quantities of a product delivered equals the quantities shipped. These are structural constraints that ensure the proper product flows, and therefore they are not subject to the constraint-by-attributes approach.

In accordance with an embodiment of the present invention a linear program is formed from the constraints mentioned in step S210. It is well-known in the art that linear programming problems are ideally suited to linear equality and inequality constraints. In an exemplary embodiment, mixed integer-linear program, a nonlinear program, a stochastic program, and the like may be formed if non-linear constraints or discrete-valued variables are part of the mathematical model.

At S220, an objective function to measure profit is created. An exemplary and non-limiting objective function that uses cash contribution as a measure of the profit is:

$$cash contribution = \sum ( sales order ' s quantity \times ( \begin{matrix}sales order ' s \\ price\end{matrix} - \begin{matrix}sales order ' s \\ cost\end{matrix} ) )$$

In the above equation, a sales order represents the most granular unit of decision making available to the mathematical model's constraints, and the sum is over all sales orders. It should be noted that other objective functions can be used, such as revenue, quantity, profit, return on assets (ROA), and so on.

As mentioned above a linear program is formed from the constraints generated at step S210 and the objective function mentioned at S220. It is well known in the art that linear programming problems involve a linear objective function and linear equality and inequality constraints. Other mathematical programming optimization engines, such as a mixed integer-linear programming engine, a nonlinear programming engine, stochastic programming optimization engine, and the likes can also be used to solve the set of constraints and the objective function.

At S230, a linear programming optimization engine is executed to determine the best feasible values of the volumes that satisfy the constraints of the attribute-based constraints. That is, the optimization engine finds, using the collected business data, a set of values that satisfy the set of constraints created at S205 and S210 and at the same time maximize the cash contribution measured by the objective function created at S220.

Referring back to FIG. 1, where at S190 an optimized business plan is output. The plan provides optimized sales order quantities, production quantities, production routings, and so on. The information is arranged in at least four different tables: an asset loading table, a route loading table, a sales order marginal value table, and an asset marginal value table. The information presented in each of these tables is described in greater in the '473 application.

Furthermore, the generated optimized plan provides useful information about the constraint groups. This information is presented in a constraint group value table 300 provided in FIG. 3. The table 300 includes the following fields: one ore more categorical attributes of the constraint group; a lower bound, an upper bound, the calculated value based on the calculation function, an optional weighting factor, and the marginal value.

The marginal value provides an estimate of the change in profit, as calculated by the objective function, by increasing the lower bound or upper bound by one unit. If the marginal value is negative, it refers to the lower bound. If it is positive, it refers to the upper bound. If it is zero, it means that neither the lower bound nor the upper bounds constrained the profit (including the case when they were both null).

As an example, Table 5 shows an output table for the demand factor example described above.

TABLE 5

| | | Deliver- | | | | | | | |
|---|---|---|---|---|---|---|---|---|---|
| | | to | | | | Lower | Upper | Calculated | Marginal |
| | Customer | Location | Gauge | Grade | Width | Bound | Bound | Value | Value |
| 1 | C1 | 94705 | 0.001 | A1 | 14.00 | 5,000 | 10,000 | 5,000 | −185.00 |
| 2 | C1 | 94331 | 0.001 | A2 | 14.00 | null | 8,500 | 1,000 | 0.00 |
| 3 | C2 | 48335 | 0.003 | A1 | 12.00 | null | 14,000 | 14,000 | 45.00 |
| 4 | C2 | 48123 | 0.003 | A1 | 12.00 | 6,300 | 6,300 | 6,300 | 54.00 |

The Table 5 includes the categorical attributes “Customer,” “Deliver-to Location,” “Gauge,” “Grade,” and “Width.” The first row shows that the Lower Bound limited the profit since its Calculated Value is equal to the Lower Bound and the Marginal Value is negative. If the company is in negotiations with customer “C1”, the company should try to negotiate a reduced Lower Bound (quantity) or a higher price. In the second row, the Lower Bound is null, thus there is no constraint. In addition the Calculated Value is below the Upper Bound, and therefore the Marginal Value is zero. In the third row, the Calculated Value is at the Upper Bound, and the Marginal Value is positive, thus the Upper Bound limits profit. If the company is in negotiations with customer “C2”, the company should explore ways to increase sales of this product at this location. In the fourth row, the Lower Bound and Upper Bound are equal, and the Marginal Value is positive. This means the Upper Bound limits profit and negotiations should focus on increasing sales of this product to this location.

The output tables may be created for other attribute-based constraints and decisions may be taken accordingly. For example, the capacity constraints described discussed above indicates which assets limit profit, and therefore, should have their capacities increased or the minimum operating times decreased, as appropriate. The attribute-based carbon-dioxide and CAFE constraints can be useful for providing estimates of cost impacts (from the Marginal Values) when assessing new regulations or changes to regulations. These forms of insights apply to other decisions, such as with supplier negotiations of guaranteed quantities and the economic impacts of setting targets such as revenue growth.

It would be apparent to a person skilled in the art that the tables and their content discussed can be presented in the form of charts, or any other tangible format in print, display, or otherwise. Furthermore, other forms of storing the output, such as in a single consolidate table for all factors, are possible.

It should be noted that the methods and processes described herein can be implemented in software, hardware, firmware or any combination thereof. Specifically, one of skill in the art would recognize that the practicalities associated with the disclosed method require a computer be used to perform the computation. A computer for the purposes of this discussion may be simply understood as a processor and an associated tangible memory storing instructions. As is well known, the instructions are performed by the processor. Thus, in other words, an embodiment of the invention resides in a tangible computer memory storing instructions for optimizing business plans, which instructions, when executed by the computer processor, enable the processor to perform certain functions as set forth below. The method is thus an automated or computer implemented method (although, of course, interaction with users, either human or other computer systems, to one degree or another is foreseen).

What is claimed is:

1. A computer implemented method for optimizing a constrained business plan according to a plurality of categorical attributes, comprising:
generating at least one attribute-based constraint to constrain a business plan, wherein the at least one attribute-based constraint is based on at least a numerical factor, a categorical attribute and at least one of a lower bound constraint and an upper bound constraint;
optimizing the business plan according to the at least one attribute-based constraint, an objective function, and collected business data of an organization to generate an optimized constrained business plan; and
outputting the optimized constrained business plan.

2. The computer implemented method of claim 1, wherein the business plan comprises at least one of: a sales plan and an asset loading plan.

3. The computer implemented method of claim 1, wherein the business data comprises at least one of: financial data, marketing data, sales data, and production data.

4. The computer implemented method of claim 3, wherein the business data is based on at least one of: historical details and projected details.

5. The computer implemented method of claim 3, wherein generating the at least one attribute-based constraint further comprises:
selecting at least one numerical factor to constrain;
selecting a constraint calculation function;
selecting at least one categorical attribute;
generating at least one constraint group based on the values of the selected categorical attribute;
generating a table that includes a lower bound and a upper bound value for each constraint group;
setting the values of the lower bound and the upper bound; and
defining an attribute-based constraint for each of the lower bound and the upper bound, if the value of each respective bound is different from a null value.

6. The computer implemented method of claim 1, wherein the categorical attribute comprises at least one of: a customer region, a customer industry, a customer market, sales orders, a deliver-to destination, a product market segment, a product group, a product width, a product gauge, an asset, a plant, and a production region.

7. The computer implemented method of claim 6, wherein the categorical attribute is predefined.

8. The computer implemented method of claim 5, wherein the numerical factor comprises at least one of: a customer quantity, a specific amount of emissions, an economic value, a fuel efficiency for a vehicle category, an amount of a resource, and an amount of a form of waste.

9. The computer implemented method of claim 5, wherein the constraint calculation function comprises at least one of: a sum, a weighted sum, and a weighted average.

10. The computer implemented method of claim 9, wherein a weighting factor is set when the weighted average is selected as the constraint calculation function.

11. The computer implemented method of claim 5, wherein the values of the lower bound and the upper bound are set by a user.

12. The computer implemented method of claim 1, wherein optimizing the business plan according to the at least one attribute-based constraint, an objective function, and collected business data of an organization to create an optimized constrained business plan further comprises:
initializing a mathematical model with the at least one attribute-based constraint;
adding to the mathematical model a set of constraints representing a plurality of structural business factors;
generating the objective function; and
determining a set of values satisfying the at least one attribute-based constraint and the set of constraints and maximizing the objective function.

13. The computer implemented method of claim 12, wherein determining the set of values is performed using a mathematical programming optimization engine.

14. The computer implemented method of claim 13, wherein the mathematical programming optimization engine comprises at least one of: a linear programming optimization engine, a mixed integer-linear programming optimization engine, a quadratic programming optimization engine, a nonlinear programming optimization engine, and a stochastic programming optimization engine.

15. The computer implemented method of claim 12, wherein the plurality of structural business factors comprises at least one of: production flow and shipping.

16. The computer implemented method of claim 12, wherein the objective function maximizes at least a profit.

17. The computer implemented method of claim 2, wherein outputting the optimized constrained business plan further comprises:
producing at least one of the following outputs: an asset loading table, a route loading table, a sales order marginal value table, an asset marginal value table, and a constraint group value.

18. The computer implemented method of claim 17, wherein the constraint group value includes for each constraint group a lower bound value, an upper bound value, a calculated value and a marginal value.

19. The computer implemented method of claim 18, wherein the marginal value provides an estimate of a change in profit, as calculated by the objective function, by increasing the lower bound or upper bound by one unit.

20. The computer implemented method of claim 17, wherein the outputs may be displayed or printed.

21. A computer program product for optimizing a constrained business plan according to a plurality of categorical attributes, the computer program product having computer instructions on a tangible computer readable medium, the instructions being adapted to enable a computer system to perform operations comprising:
generating at least one attribute-based constraint to constrain a business plan, wherein the at least one attribute-based constraint is based on at least a numerical factor, a categorical attribute and at least one of a lower bound constraint and an upper bound constraint;
optimizing the business plan according to the at least one attribute-based constraint, an objective function, and collected business data of an organization to create an optimized constrained business plan; and
outputting the optimized constrained business plan.

22. The computer program product of claim 21, wherein the business plan comprises at least one of: a sales plan and an asset loading plan.

23. The computer program product of claim 21, wherein the business data comprises at least one of: financial data, marketing data, sales data, and production data.

24. The computer program product of claim 23, wherein the business data is based on at least one of: historical details and projected details.

25. The computer program product of claim 23, wherein generating the at least one attribute-based constraint further comprises:
selecting at least one numerical factor to constrain;
selecting a constraint calculation function;
selecting at least one categorical attribute;
generating at least one constraint group based on the values of the selected categorical attribute;
generating a table that includes a lower bound and a upper bound value for each constraint group;
setting the values of the lower bound and the upper bound; and
defining an attribute-based constraint for each of the lower bound and the upper bound, if the value of each respective bound is different from a null value.

26. The computer program product of claim 21, wherein the categorical attribute comprises at least one of: a customer region, a customer industry, a customer market, sales orders, a deliver-to destination, a product market segment, a product group, a product width, a product gauge, an asset, a plant, and a production region.

27. The computer program product of claim 26, wherein the categorical attribute is predefined.

28. The computer program product of claim 25, wherein the numerical factor comprises at least one of: a customer quantity, a specific amount of emissions, an economic value, a fuel efficiency for a vehicle category, an amount of a resource, and an amount of a form of waste.

29. The computer program product of claim 25, wherein the constraint calculation function comprises at least one of: a sum, a weighted sum, and a weighted average.

30. The computer program product of claim 29, wherein a weighting factor is set when the weighted average is selected as the constraint calculation function.

31. The computer program product of claim 25, wherein the values of the lower bound and the upper bound are set by a user.

32. The computer program product of claim 21, wherein optimizing the business plan according to the at least one attribute-based constraint, an objective function, and collected business data of an organization to create an optimized constrained business plan further comprises:
initializing a mathematical model with the at least one attribute-based constraint;
adding to the mathematical model a set of constraints representing a plurality of structural business factors;
generating the objective function; and
determining a set of values satisfying the at least one attribute-based constraint and the set of constraints and maximizing the objective function.

33. The computer program product of claim 32, wherein determining the set of values is performed using a mathematical programming optimization engine.

34. The computer program product of claim 33, wherein the mathematical programming optimization engine comprises at least one of: a linear programming optimization engine, a mixed integer-linear programming optimization engine, a quadratic programming optimization engine, a nonlinear programming optimization engine, and a stochastic programming optimization engine.

35. The computer program product of claim 32, wherein the plurality of structural business factors comprises at least one of: production flow and shipping.

36. The computer program product of claim 32, wherein the objective function maximizes at least a profit.

37. The computer program product of claim 22, wherein outputting the optimized constrained business plan further comprises: producing at least one of the following outputs: an asset loading table, a route loading table, a sales order marginal value table, an asset marginal value table, and a constraint group value.

38. The computer program product of claim 37, wherein the constraint group value includes for each constraint group a lower bound value, an upper bound value, a calculated value and a marginal value.

39. The computer program product of claim 38, wherein the marginal value provides an estimate of a change in profit, as calculated by the objective function, by increasing the lower bound or upper bound by one unit.

40. The computer program product of claim 37, wherein the outputs may be displayed or printed.
